(19) United States
(12) Patent Application Publication
(10) Pub. No.: US 2022/0371353 A1
(43) Pub. Date: Nov. 24, 2022

(54) Book Page Holder Device

(71) Applicant: Andrew Francis Blanchard, San Antonio, TX (US)

(72) Inventor: Andrew Francis Blanchard, San Antonio, TX (US)

(21) Appl. No.: 17/679,714

(22) Filed: Feb. 24, 2022

Related U.S. Application Data
(60) Provisional application No. 63/192,030, filed on May 23, 2021.

(51) Int. Cl. B42D 9/00

(52) U.S. Cl. CPC B42D 9/00

(57) ABSTRACT

A device for securing pages of a book in an open position. The device operates as a unitary Improved Book Page Holder in a secure manner that is effective without presenting intricate, moving or visibly obstructive parts. In particular, the device includes discretely separate flanges that interface open pages at apex locations thereof. Simultaneously, a central wedge component is provided is inserted into a crevice between the open pages. Thus, discrete wedge points of tension-pressure are introduced by way of the wedge component which occurs in unison with tension-pressure from the flanges at the apex locations. Therefore, as a practical matter, a unique form of securing and holding is provided that maintains the pages of a book in an open position until a user intends to advance device to the next pair of adjacent book pages or until removal of the device takes place.

### PRIORITY CLAIM/CROSS REFERENCE TO RELATED APPLICATION(S)

This Patent Document claims priority under 35 U.S.C. § 119 to U.S. Provisional Application Ser. No. 63/192,030, filed May 23, 2021, and entitled, “Improved Book Page Holder”, which is incorporated herein by reference in its entirety.

### BACKGROUND

Traditional books with conventional pages still remain favorites of today's modern readers in spite of the availability of alternative electronic formats. Indeed, for many serious consumers of literature, traditional tangible books with conventional paper pages may always remain the majority for absorbing literary content. Unfortunately, for the traditional book consumer, like for the rest of us, the fast-paced, technology-driven world of today remains. This means that such consumers may already be used to absorbing content while performing a variety of other multitasking events such as cooking, eating, working out on a exercise bike or treadmill, computer work, watching TV, using a remote control, texting on cell phone, or taking written notes. However, when it comes to performing such tasks while at the same time absorbing content in book form, there is a particular challenge. That is, unlike propping up a computer tablet in the kitchen, a book user is faced with the challenge of opening a book, reading the current adjacent pages and keeping the current adjacent pages open, while also potentially attempting to multitask in other more modern activities. These traditional books with conventional pages that are preferred by more traditional readers, present more of a challenge to use in this technology-driven world we currently live in. In this regard, many efforts have been undertaken to help users try and keep book pages open while reading in a hands-free manner. For example, one of the more popular techniques for keeping a book open to the proper pages, is to utilize a book weight in which the weight spans across open book pages in an obscuring, unstable, non-secure, and clumsy manner for moving book weight from page to page. Furthermore, being of some weight and substance, a book weight is likely to be of denser non-transparent construction. Thus, portions of the pages are covered by the book weight in keeping the book open and remain unreadable by the reader without repositioning the book weight. Other non-transparent, page holding efforts have been undertaken as well attempting to accomplish hands-free reading but found to make reading even more cumbersome and obscure the printed text, photos or graphics on each page. Many examples require the use of one or more hands, rendering the user unable to multitask using both hands. Other examples can cause damage to the pages by inserting wire, rods, or other various metal shaped devices between pages. In other examples, book pages may be retained by implements on a music stand or devices that individually interface and clasp book pages open, making it difficult to quickly turn pages. Further examples are heavy, complicated to use, and not designed for portability where portability is important in today's technology-driven world with high-tech fitness centers, facilities, and transportation. However, the examples mentioned are not be specifically designed for portability and can further risk damage to book pages such as where the wind or the user, unintentionally begins to turn the books pages while still being retained by such devices. As a result, while perhaps not as portable-friendly, readers of traditional books tend to stick with the conventionally cumbersome, but safe techniques of handheld book reading aided by a bookmark and no more.

### SUMMARY

A book page holder device for securing book pages in an open position is disclosed. The device is configured to interface an open book displaying a profile with curved pages and top surface apex locations of adjacent pages extending upward from a spine of a book. The device includes a central located handle component and wedge component for insertion into the crevice area between book pages towards spine of a book when in the open position to reach maximum crevice depth. The device also includes laterally extending, flange components discrete from the wedge component. The perpendicular flanges are fastened to a location over the wedge component for traversing widths of each side of adjacent book pages extending sufficiently, while simultaneously interfacing the apexes of adjacent book pages for securing the book in the open position.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1 is a top perspective view of an embodiment of a book page holder device for keeping pages of a book in an open position.

FIG. 2 is a top perspective view of an alternate embodiment of the book page holder device of FIG. 1.

FIG. 3a is a profile view of the book page holder device of FIG. 2 wedged within a crevice of a book for keeping pages of a book in an open position including an enlarged, cross-section detail illustrating key components of device.

FIG. 3b is a enlarged detail view of book page holder device of FIG. 3a illustrating the surface sides of wedge component being comprised of tacky, page-gripping type materials.

FIG. 3c is a profile view of the book page holder device of FIGS. 3a and 3d being positioned between pages of a manually held open book.

FIG. 3d is a profile view of the book page holder device of FIG. 3c, illustrating left and right flanges, perpendicular to a wedge component of the device interfacing with apex locations of adjacent pages of a book.

FIG. 3e is a profile view of the book page holder device of FIG. 3d illustrating the device has moved into a secure position of crevice area of a book and the wedged component is shown reaching maximum crevice depth simultaneously making firm, pressure contact to apex points of adjacent pages.

FIG. 4a-4d are profile cross-section views of alternate embodiments of book page holder device utilizing various types of fastening methods of wedge components to stem component.

FIG. 5 is a top perspective overview of a user interfacing an open book with an embodiment of book page holder device illustrating multiple, functional features of the embodiment.

FIG. 6 is a top view of various embodiments of book page holder device illustrating various shaped, flange components of the device that includes optional shapes for marketing strategies.

FIG. 7 is a flow-chart summarizing an embodiment of utilizing a book page holder device keeping adjacent pages of a book in an open position allowing a user the option to multitask.

### DETAILED DESCRIPTION

Embodiments are described with reference to the use of a certain book page holder device embodiments. Specifically, a book page holder device for keeping adjacent book pages of a book in an open position is illustrated. The device may take on a variety of different shapes and morphologies and still function and perform as intended. So long as the device includes a flexible, central wedge component for wedging into and utilize the natural tightness crevice area that all spine-type books possess. Thus, gripping at crevice contact points between adjacent book pages occurs in unison with discrete flange components for interfacing adjacent apexes of the book pages such that appreciable benefit may be realized. Furthermore, the term, “book” as used herein is not meant to infer any particular type of hardcover, paperback book, or the like. Rather, any tangible, multi-page-based type of materials may be referred to herein as a book which may include novels, music books, DIY's, magazines, lab notebooks, or any number of other reading or other types of literature consisting of a crevice-bound, spine book. Furthermore, the term “wedge component” herein shall be defined as an “elongated, wedge-shaped, tacky, page-gripping, flexible, component”. The wedge component can be manufactured of various tacky, gripping type materials such thermoplastic elastomers, silicon, rubber, mico-suction, or other similar materials not mentioned, thus, effectively adding gripping functionality to device.

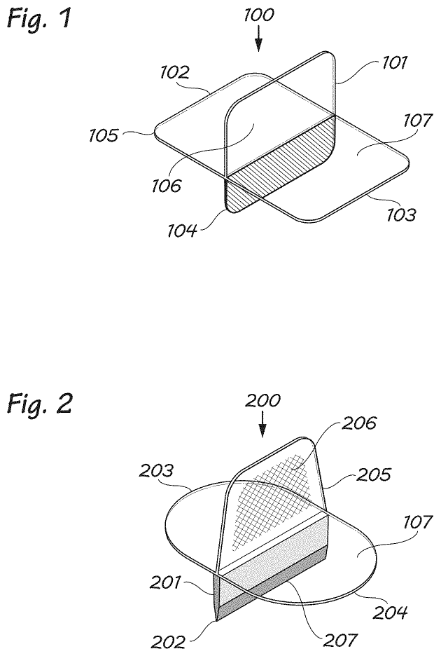

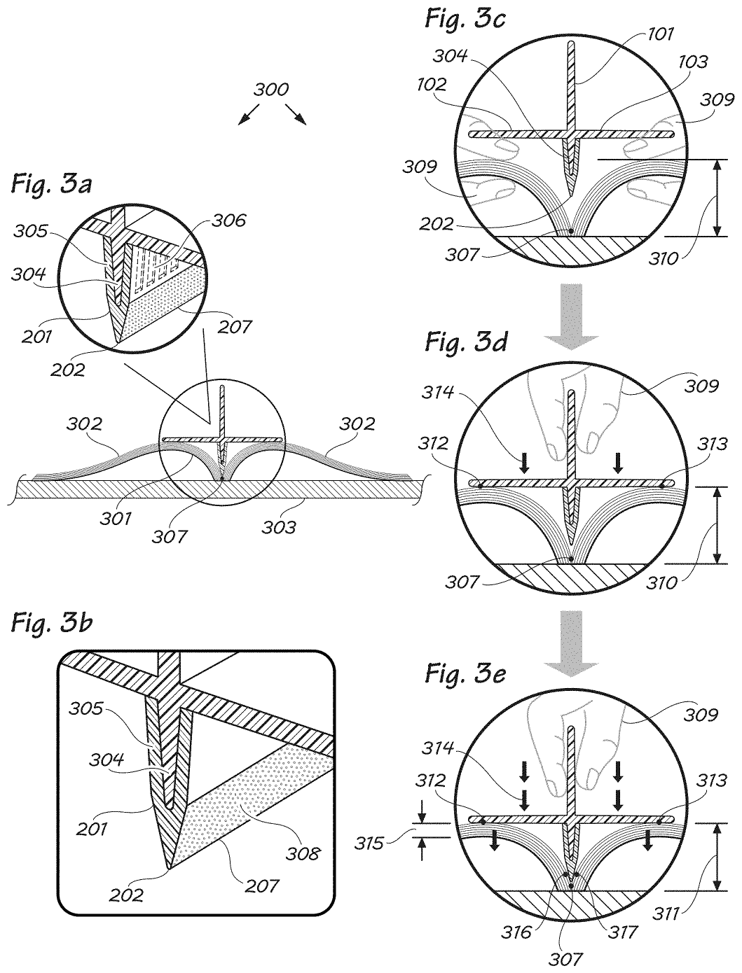

Referring specifically now to FIG. 1, a top perspective view of an embodiment of a book page holder device 100 identifying key components of devices is illustrated for keeping pages of a book 302 in an open position. The device includes an upper, central handle component 101 oriented on a vertical plane 106 used for manipulation of the device during use. On the same vertical plane 106, the device shares a lower, fastened, central wedge component 104 that is configured for insertion of a given depth into crevice 307 between book pages 302 of a book 301 (see FIG. 3a). Perpendicular to the handle component 101 and vertical plane 106, left and right discrete flanges 102, 103 approximately divide the handle component 101 and wedge component 104. The discrete flanges 102, 103 are each configured to make direct contact by interfacing with apexes 312, 313 of adjacent book pages 302 as illustrated in FIG. 3e. As detailed in FIGS. 3a and 3e, this interfacing occurs in unison with the behavior of the wedge component 101 and serves to render a book page holder device 100 which securely keeps pages of a book 302 in an open position (again see FIGS. 3a and 3e).

Continuing with reference to FIG. 1, the wedge component 104 (term defined earlier) is shown with a tacky, gripping surface to enhance a coefficient of friction thereof. In this way, the wedge component 104 presents a tacky, textured or gripping surface (See FIG. 3b) contacting book pages 302 during wedging process therebetween as illustrated in FIGS. 3a and 3e. Thus, as the wedge component 104 is forcibly engaged with both the crevice 307 and wedge contact points 316, 317 of adjacent book pages 302, resistance to disengagement is provided. This occurs in unison with left and right flanges 102, 103 interfacing with the apexes 312, 313 of the book pages 302 so as to create a synergistic securing of the device 100, 200, 300 in place and as illustrated in FIGS. 3a-3e.

In the embodiment of FIG. 1, the left and right flanges 102, 103 are rectangular in shape with rounded corners 105. In this way, both the user and the book pages 302 may avoid interfacing sharper corners during use. Additionally, the illustrated material of flanges 102, 103 is transparent. Thus, a user may view printed material from book pages 302 even when wedged into position for securing the book pages 302 in the open position. For this reason, it may also be advantageous for the handle component 101 to be transparent. In embodiments 100, 200, 300, the flanges 102, 103 and handle 101 components are of a transparent 107 plastic, polypropylene, polystyrene, polyvinyl chloride (PVC), polycrystalline or other suitable material. Of course, a variety of other features, materials, and enhancements may be incorporated into the device 100, 200, 300.

Referring now to FIG. 2, a top perspective view of a preferred embodiment of a book page holder device 200 is illustrated. In this embodiment, a safer device 200 with smooth edges and a soft feel is provided. Furthermore, a more refined device 200 is illustrated with additional enhancements. For example, 200 illustrates rounded-diameter shaped left and right flanges 203, 204 such that a top view of the combined flanged surfaces present a generally oval shape such as illustrated at 200, 300 of FIG. 6. This embodiment provides an added degree of safeguarding to book pages 302 during securing with the device 200 such as when wind may occur, or a user unintentionally begins to turn a page 302 when the device is in a secured position as illustrated in FIGS. 3a and 3e.

In addition to the rounded-diameter shaped flanges 203, 204, the handle component 205 of the embodiment 200 of FIG. 2 is of a more tapered and ergonomic shape and requiring less material. Further, the handle component 205 includes a gripping surface 206 to facilitate improved gripping by a user who is manually inserting, removing or otherwise manipulating the device 200. Additionally, the illustrated handle component 205 is transparent. In one embodiment, this gripping surface 206 may include knurled, raised, or irregular surface features as illustrated. However, in other embodiments, the surface 206 may incorporate an embossed design or pattern such as a promotional name or logo for additional promotional or marketing purposes while also serving as a means for gripping.

Continuing with reference to FIG. 2, particular attention is drawn to the wedge component 201 and terminus end point 202. In this embodiment, the device 200 may be generally comprised of a slightly flexible but overall rigid, transparent plastic 107 or other suitable material. However, the wedge component 201 may consist of a discrete, separately provided element of enhanced gripping character without concern over clarity or transparency. For example, in one embodiment, the wedge component 201 includes a central stem 304 (illustrated in FIGS. 3a and 3b), of rigid device material that supports, or is secured by, a wedge component 201 of silicon, thermoplastic elastomer, rubber, or any of a variety of tacky, textured, gripping, or micro-suction materials providing an enhanced coefficient of friction to the wedge component 201. Thus, an enhanced tacky, grip-like, surface 308 illustrated in FIG. 3b, is presented to serve the unique wedge function between adjacent book pages as suggested above and further detailed.

The wedge component 201 illustrated is also tapered in a specific manner to maximize contact with adjacent pages 302 illustrated in FIGS. 3a and 3e, and may be flexible or compressible. That is, by way of contrast to the more rigid structure and material of the remainder of the device, the wedge component 201 may be more pointed, flexible and compressible, creating a greater coefficient of friction between adjacent crevice contact points 316, 317 of adjacent pages 302. These characteristics help promote the described wedge function of the wedge component 201 as detailed herein. Along these lines, it is also worth noting that for the illustrated embodiment, the wedge component 201 has straight edges or sides. More specifically, in the embodiment shown, the wedge component 201 comprises of straight edges or sides 207 that taper into the terminus end point 202. That is, rather than utilizing a concave or matching shape to interface curved book pages 302 of an open book 301, edges or sides 207 described are utilized to enhance a counteractive gripping pressure between the adjacent pages 302 and the wedge component 201 as detailed further below (see FIGS. 3d and 3e). The straight, tapered sides 207 are further described in FIG. 3b.

Referring now to FIG. 3a, a profile view of preferred embodiment of book page holder device 300 is illustrated. In this embodiment, the device 300 is shown wedged within a book crevice 307 and securing pages 302 open thereof at a resting surface 303. An accompanying enlarged sectional view of the wedge component 201 is illustrated. For this embodiment, the wedge component 201 includes similar morphology and construction to the embodiment of FIG. 2, with straight, tapered sides 207 that reach a terminus or end point 202. Thus, as described above, the combined features of wedge component 201, terminus end point 202, and straight, tapered sides 207 are well suited for forcibly wedging into a crevice 307 between adjacent book pages 302 toward a spine of a book 301 as shown, keeping pages of a book 302 in an open position.

In addition to the features detailed above, the wedge component 201 and device 300 are shown in cross-section in FIGS. 3a and 3b to reveal an internal stem 304 used to support, accommodate or fasten a discretely, separate wedge element 305 such that together, the wedge component 201 is provided. In the embodiment shown, the element 305 is secured to a ridged, ribbed, or otherwise tailored morphology surface 306 of the underlying stem 304. Thus, the element 305 may include it's own interlocking morphology, be bonded by glue channels, or other conventional fastening methods to the stem 304. However, in other embodiments, the element 305 may be provided by way of conventional over-molding process.

Continuing with reference to FIG. 3a, the book page holder device 300 is shown wedged in place with the wedge component 201 seated firmly in position between adjacent pages 302 with the flanges 102, 103 cooperatively retaining these adjacent pages 302 at apex locations 312, 313 thereof (see FIGS. 3d and 3e). This synergistic securing by the cooperating components 102, 103, 201, 203, 204 renders a book 301 and book pages 302 retained in an open position for reading in a hands-free manner. Thus, the user has the option to perform multitasking events such as intermittently cooking, eating, reading, exercising, texting, taking notes, or whatever else the user may be engaged in without undue concern over the book 301 closing or pages 302 being unintentionally turned or closed. Once more, even if not multitasking, the potential physical drain or fatigue on the user in keeping the book open to a given pare of pages for an extended period of time is eliminated. This is achieved with no more than the minimal effort of placing the device 300 into a crevice of a book 301. The book 301 may be held to the current pair of adjacent book pages 302 being read substantially indefinitely until user is ready to move device 300 to next adjacent book pages 302.

Referring now to FIG. 3b, illustrated is a detailed surface 308 of the straight edges or sides which may further comprise of a tacky, gripping, textured, or micro-suction surface 308 to provide even further gripping enhancements between the wedge component 201, element 305, and adjacent book pages 302.

Referring now to FIG. 3c, a profile view of the the book page holder device 300 is illustrated being positioned between adjacent book pages 302 of the book 301 of FIG. 3a. In this view, the book 301 is shown being manually held open by a user's hands 309 in a normal held position. This presents an arch distance 310 between the resting support surface 303 which naturally creates apexes of the open book 301 adjacent pages 302 (e.g. such as apex points 312, 313 shown in FIGS. 3d and 3e). Once more, the terminus end point 202 of the wedge component 201 is configured to substantially traverse this distance 310 to reach crevice point 307 where the exposed adjacent book pages 302 meet.

Continuing now with reference to FIG. 3d, a profile view of the the book page holder device 300 of FIG. 3c is shown illustrating flanges 102, 103 making first interfacing contact with the above noted apexes 312, 313 of book pages 302. In the illustration, a user's hand 309 is shown firmly gripping the handle 101 to forcibly insert the wedge component 201 of the device 300 toward the crevice point 307 as described above (see traverse arrows 314). However, in order to reach the maximum crevice point 307 depth, the flanges 102, 103, 203, 204 first engage with the apexes 312, 313. In the illustration shown, the engagement with the apexes 312, 313 occurs substantially prior to the terminus end point 202 reaching the crevice point 307 with the initial distance 310 remaining unchanged. Other embodiments of 100, 200, 300 and the wedge component 201, can accommodate various book sizes and type of books (e.g. paperback, hardback, or others).

Referring now to FIG. 3e, a profile cross-section view of the the book page holder device 300 of FIG. 3d is shown wedging into a firm gripping, secured position between adjacent book pages 302. More specifically, continued forceful advancement of the device 300 wedge component 201 toward the crevice point 307 results in a unique, coefficient of friction and gripping between wedge component 201 and adjacent book pages 302. For example, note that the apexes 312, 313 and adjacent book pages 302 are both lowered and compressed 315 simultaneously (see compression arrows 315) to a degree by the continued downward movement (traverse arrows 314) of the device 300. Thus, the total traverse distance is reduced (e.g. from 310 of FIGS. 3d to 311 of FIG. 3e). More notably, the wedge component 201 has physically and securely engaged with wedge contact points 316, 317 with the adjacent book pages 302 maximum crevice depth 307. Recalling from FIGS. 3a and 3b that the wedge component sides 207 are likely of straight, non-matching, morphology in contrast to the arched shape of the book pages 302, an added degree of firm pressure is applied through the book pages 302 to the wedge component 201. Thus, a tighter wedging of the device 300 is achieved. Once more, the compressing of the apex locations 312, 313 also provides an added degree of firm pressure with respect to the flanges 102, 103 at the adjacent pages. Thus, the occurrence of simultaneous pressure is created during final stages of insertion process of device 300, through tensive cooperating apex 312, 313, crevice point 307, and wedge contact points 316, 317 points of adjacent book pages 302. Therefore, keeping adjacent book pages in an open position is enhanced. Indeed, the combination of an added appropriate coefficient of friction and gripping between adjacent paper pages 302, the device 300 may be firmly seated into the tight crevice point 307. When considering the tacky, gripping, textured, or micro-suction surface 308 material of the wedge component 201, the odds of the device 300 becoming accidentally dislodged is highly unlikely. Rather, dislodging is only likely when the device 300 is manually removed (e.g. and moved to the next pair of adjacent book pages 302).

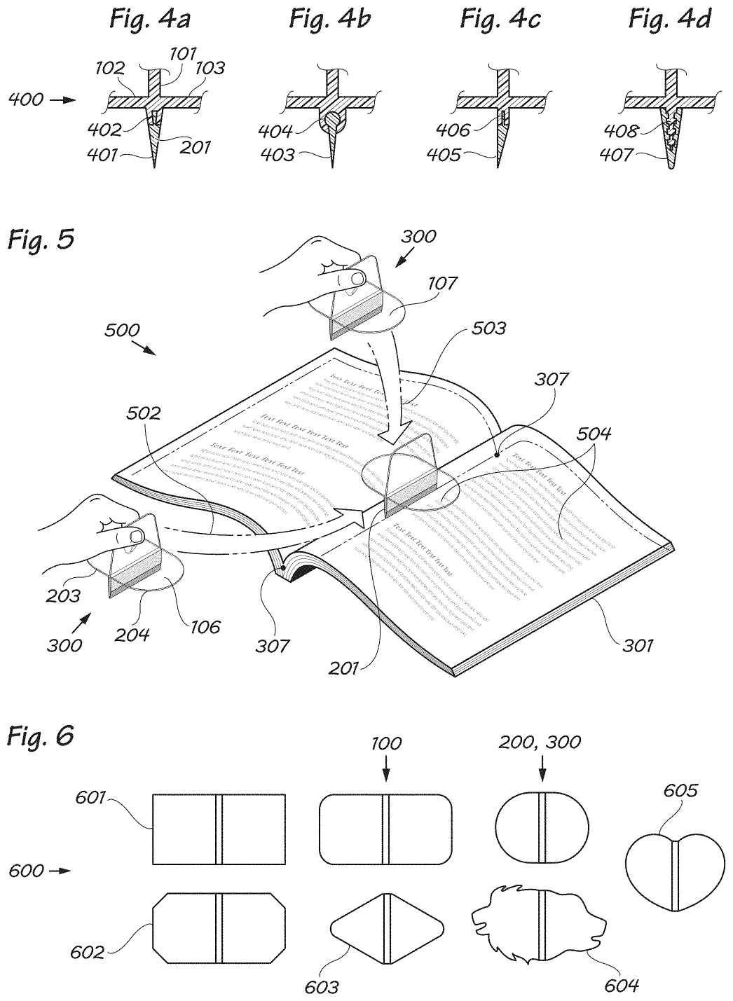

Referring now to FIGS. 4a-4d, profile cross-section views of alternate embodiments of the book page holder device 400 are shown utilizing different types of wedge component morphologies and fastening methods between upper, transparent body 107 and wedge component 201. Specifically, FIGS. 4a-4c illustrate devices 400 where the handle 101 and flange 102, 103, components are formed as a unitary structure that extends into an upper portion of the wedge component 201, which is used to fasten and secure a centrally retained wedge element 401, 403, 405. For these embodiments, an extension 402, 404, 406 from the wedge element 401, 403, 405 is illustrated for secure, fastening by the noted upper portion of the wedge component 401, 403, 405. Alternatively, the embodiment of FIG. 4d illustrates a different type of offsetting, keyed stem 408 configuration of the upper portion of the wedge component 201 that is surrounded by and fastened to wedge element 407. Note, these embodiments are not limited to such fastening methods. Other various fastening methods and manufacturing techniques may be utilized including over-molding.

Referring now to FIG. 5, a top perspective overview of a user interfacing an open book 301 is illustrated with an embodiment of the book page holder device 300 as detailed hereinabove. As illustrated, a user may position the device 300 by directing it in a top, downward direction toward the book adjacent pages 302 and crevice 307 as shown at arrow 503. However, the user manipulating the device 300, may also approach the open book 301 from a more lateral angle by sliding and depressing the device down into the book crevice 307 as shown at arrow 502. In either circumstance, the device 300 is secured at maximum crevice 307 depth and as described above to keep the pages 302 of a book 301 in the open position as illustrated. Thus, the user is afforded the option to use their hands to perform other multitasking events such as cooking, eating, exercising, taking notes, working with a computer, watching TV in bed with bed stand, or any number of other activities. Recalling that the handle 101 and flanges 102, 103 are preferably transparent, the device 300 also avoids obstructing the user's view of printed text and/or other imagery on book pages. Thus, the main, upper transparent body 107 components which includes components 101, 102, 103, 203, 204, 205 allows the reader to visually see through body 107 components and read any printed text 504 (or view photos and graphics) on adjacent pages 302 without reason to reposition the device 300 up or down the crevice of a book 301.

Referring now to FIG. 6, top views of various embodiments of the book page holder devices 601, 602, 603, 604, 605, 100, 200, 300, with differing optional morphologies are illustrated. Specifically, these morphologies differ for flange components of the devices. So, for example, the preferred rounded-diameter 200, 300 morphology which is the focus of FIGS. 2, 3a-3e, and FIG. 5 may be utilized. However, more rectangular 601, 45° corner 602, rounded corner 100 as in the embodiment of FIG. 1, or perhaps diamond or triangular 603 morphologies may be also be utilized. The Embodiments 604, 605 also illustrates flanges in other marketing design shape options such animal, heart or other shapes. Thus, the functionality of the book page holder device 300 remains. Indeed, the handle 101 could also comprise of such marketing design shapes.

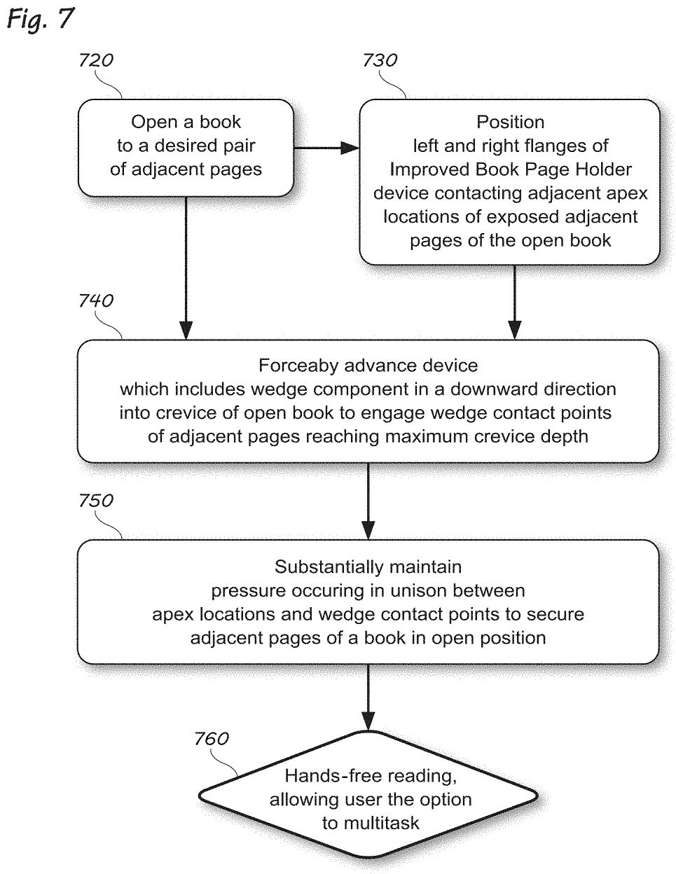

Referring now to FIG. 7, a flow-chart is presented which summarizes methods of utilizing a book page holder device for keeping pages of a book an in open position for reading by a user. For example, a user that may or may not be in an outdoor or active environment, may open a book to a desired pair of adjacent page as indicated at 720. A book page holder device as detailed herein, is then positioned with left and right flanges at apex locations of exposed adjacent pages of the book (see 730). As indicated at 740, a wedge component of the device is forcibly advanced toward a crevice point of the open book to engage a wedge contact point at each of the adjacent pages. Thus, as shown at 750, simultaneous firm pressure occurs and is maintained between the apex locations, crevice point, and the engaged wedge contact point to keep the book open for the user to read or otherwise use the book. Thus, the option to obtain hands-free reading 760 for the user by way of a book page holder device is achieved.

### Advantages of Book Page Holder Device

The advantages and unique innovation of book page holder device are numerous:
Uniquely utilizes the crevice and apex areas of a book, keeping adjacent pages of a book to stay in an open position.
Includes left and right flanges that work in unison with wedge component, wedge contact point wedge, and crevice point for securing device in place.
Flanges or handle can be manufactured in various shapes.
The main, upper body of the device is transparent. Thus, when secured in place, allows the reader to visually see directly through the device to read text or view any photos, or graphics.
Lightweight, flexible, portable, easy and simple to use.
Use in the home, office, gym, or in bed with bed stand.
Great for teachers, students, lawyers, clerks that use desks or tables.
Easy to insert into the crevice of a book using a conveniently located handle.
Cost effective to manufacture with anticipated excellent sales profit margins.
Aesthetically pleasing.
Will not damage any of the books pages as could happen with prior art.
Will not leave any unwanted residue or markings behind on pages.
Only requires a small amount of material to manufacture, keeping costs low.
Shipping cost will be lower compared to other heavy, prior art.
No moving parts other than it being flexible in areas.
Smooth, safe edges, and soft feel in areas.
Not complicated to use like many other prior art.

Embodiments described hereinabove include a device for keeping pages of a book in a open position in a non-cumbersome manner that avoids undue visible blocking of printed text, photos or graphics on pages of a book. The device avoids damaging book pages during use, even in circumstances of unintentional page turning. As a result, conventional, tangible book reading takes place in a more convenient manner that is more consistent with today's multitasking, portable lifestyle engaged in by modern readers.

The preceding description has been presented with reference to presently preferred embodiments. Persons skilled in the art and technology to which these embodiments pertain will appreciate that alterations and changes in the described structures and methods of operation may be practiced without meaningfully departing from the principle scope and functionality of these embodiments. For example, a variety of differently sized device embodiments employing the principles herein may be developed to operate and function with a variety of different types or sizes of books, or other tangible page literature bound by a spine, containing a book crevice. Furthermore, the foregoing description should not be read as pertaining only to the precise structures described and shown in the accompanying drawings, but rather should be read as consistent with and as support for the following claims, which are to have their fullest and fairest scope.

The invention claimed is:

1. A book page holder device for use with a book in an open position, adjacent pages of the open book displaying a profile with an arch leading to apex points on top surfaces of the adjacent book pages, each extending upward from a spine of the book, the device comprising:
a central wedge component for insertion into a crevice between exposed book pages of the book when in the open position; and
laterally extending discrete flanges fastened to a location over the wedge component, the flanges for traversing widths of the adjacent book pages to an extent sufficient for interfacing the apex of adjacent book pages for maintaining the book in the open position.

2. The device of claim 1 wherein the wedge component comprises an exterior surface with an enhanced coefficient of friction.

3. The device of claim 2 wherein the wedge component comprises an element fastening to a stem to provide the enhanced coefficient of friction.

4. The device of claim 3 wherein the element is one of flexible and compressible and of a material selected from a group consisting of silicon, thermoplastic elastomer, and rubber.

5. The device of claim 3 wherein the stem is of a tailored morphology for the fastening.

6. The device of claim 5 wherein the tailored morphology comprises a ribbed profile to define fastening glue channels securing the wedge element to the stem for the fastening.

7. The device of claim 1 wherein the wedge component is tapered to a terminus end point for the insertion into the book crevice.

8. The device of claim 7 wherein the tapered wedge component comprises substantially straight sides in contrast to the arch of the book pages to facilitate firm pressure therebetween for reaching a maximum crevice depth.

9. The device of claim 1 wherein the central wedge component and handle component share a vertical plane for manipulation by a user to facilitate the insertion.

10. The device of claim 9 wherein the handle comprises a gripping, irregular surface.

11. A system comprising:
a book with a spine;
adjacent pages of the book defining a crevice therebetween with each page presenting an arch leading to a top page surface apex point when the book is opened to the adjacent pages;
a book page holder device with a central wedge component for insertion into the book crevice and having laterally extending, discrete flanges fastened to a location over the wedge component, the flanges for traversing widths of each of the book pages to an extent sufficient for interfacing the apex of each adjacent book pages for maintaining the book in the open position.

12. The system of claim 11 wherein the laterally extending, discrete flanges are rounded for one of protecting the opposing pages and user safety.

13. The system of claim 11 wherein the laterally extending, discrete flanges are of a promotional, marketing design shape.

14. The system of claim 11 wherein the wedge component extends below the flanges to an optimum, functional distance.

15. The system of claim 11 wherein the wedge component comprises a stem extension that is one of keyed, ribbed, and channeled for securing a wedge element therebetween.

16. A method of keeping book pages in an open position, the method comprising:
opening a book to expose a crevice between adjacent pages of the book;
positioning flanges of a book page holder device at adjacent apex locations of the pages; and
forcibly advancing a wedge component of the device toward a crevice point of the book's crevice to engage a wedge contact point at each of the adjacent pages.

17. The method of claim 16 wherein the apex locations are presented by an arch of each adjacent page of the open book, each apex location a given distance from a surface supporting the book, the forcibly advancing of the wedge component comprising reducing the given distance.

18. The method of claim 17 wherein the wedge component comprises a surface with a character of an enhanced coefficient of friction with respect to the pages, the friction for maintaining the reduced distance.

19. The method of claim 18 wherein the friction and reduced distance introduces a pressure between the wedge component and wedge contact points of the pages.

20. The method of claim 19 wherein the introduced pressure occurs in unison with another pressure between the flanges and the adjacent pages at the apex locations to secure the device in place with the book in the open position.
